(19) United States
(12) Patent Application Publication
(10) Pub. No.: US 2020/0078943 A1
(43) Pub. Date: Mar. 12, 2020

(54) ROBOT CONTROL METHOD, ROBOT CONTROL APPARATUS AND ROBOT

(71) Applicant: BEIJING JINGDONG SHANGKE INFORMATION TECHNOLOGY CO., LTD., Beijing (CN)

(72) Inventors: Peng SONG, Beijing (CN); Zongjing YU, Beijing (CN); Chao ZHANG, Beijing (CN); Guangsen MOU, Beijing (CN)

(73) Assignee: BEIJING JINGDONG CENTURY TRADING CO., LTD., Beijing (CN)

(21) Appl. No.: 16/613,639

(22) PCT Filed: Apr. 25, 2018
(86) PCT No.: PCT/CN2018/084402

§ 371 Date: Nov. 14, 2019

(30) Foreign Application Priority Data
May 16, 2017 (CN) 201710341099.5

(51) Int. Cl. B25J 9/16; G06K 9/00; G05D 1/02

(52) U.S. Cl. CPC B25J 9/1664; G05D 1/0214; G06K 9/00664; G06K 9/00362

(57) ABSTRACT

The present disclosure provides a robot control method, a robot control apparatus and a robot, which relates to the field of automatic control. The robot control apparatus identifies a bound user by identifying features of users to determine a current position of the bound user, determines a first path for the robot to move to an adjacent area of the bound user, and drives the robot to move to the adjacent area of the bound user along the first path.

The present application is based on and claims priority to CN application No. 201710341099.5 filed on May 16, 2017, the disclosed content of which is hereby incorporated in the present application as a whole.

### TECHNICAL FIELD

The present disclosure relates to the field of automatic control, and in particular, to a robot control method, a robot control apparatus and a robot.

### BACKGROUND

Shopping places such as supermarkets, shopping malls and the like provide shopping carts for users at present. The user pushes the shopping cart to select commodities in the shopping place and places the selected commodities in the shopping cart, which is convenient for the user in shopping.

### SUMMARY

The inventor has realized that, since the shopping cart has to be pushed by the user in order to move, the user cannot do some activities such as using a mobile phone, picking up a product, and the like while pushing the shopping cart. In addition, for consumers with babies or inconvenient mobility or the young or the old, it is more difficult to push a shopping cart while walking.

To this end, the present disclosure provides a solution for a shopping cart to follow the user by moving by itself.

According to a first aspect of an embodiment of the present disclosure, a control method for a robot is provided. The method comprising: identifying a bound user by identifying features of users to determine a current position of the bound user; determining a path for the robot to move to an adjacent area of the bound user; driving the robot to move to the adjacent area of the bound user along the path.

In some embodiments, the driving the robot comprises: detecting whether an obstacle appears in front of the robot in a process of driving the robot to move along the path; controlling the robot to pause in a case where the obstacle appears in front of the robot; detecting whether the obstacle disappears after a predetermined time; driving the robot to continue to move along the path in a case where the obstacle disappears.

In some embodiments, the method further comprises: detecting a ambient environment of the robot in a case where the obstacle still does not disappear; re-determining a path for the robot to move to the adjacent area of the bound user according to a result of detection; driving the robot to move to the adjacent area of the bound user along the re-determined path.

In some embodiments, in the adjacent area of the bound user, a distance between the robot and the bound user is greater than a first predetermined distance and less than a second predetermined distance, wherein the first predetermined distance is less than the second predetermined distance.

In some embodiments, the method further comprising: identifying barcode information on an adjacent shelf in a process of driving the robot to move; inquiring broadcast information corresponding to the barcode information; playing the broadcast information.

In some embodiments, the playing the broadcast information comprises: extracting an identifier of the broadcast information; determining whether the identifier matches with historical data of the bound user; playing the broadcast information in a case where the identifier matches with the historical data of the bound user.

In some embodiments, the method further comprises: acquiring voice information of the bound user and recognizing the voice information in a process of driving the robot to move; analyzing the voice instruction to obtain corresponding response information; determining a path for the robot to move to a destination address in a case where the destination address is included in the response information; driving the robot to move along a determined path to lead the bound user to arrive at the destination address.

In some embodiments, the method further comprises: playing predetermined guidance information in a process of driving the robot to move along the determined path.

In some embodiments, the method further comprises: playing reply information in a case where the reply information is included in the response information.

In some embodiments, the method further comprises: switching a state of the robot to a working state based on a trigger instruction sent by an operating user in a case where the robot is in an idle state; taking the operating user as the bound user and recognizing the features of the bound user.

In some embodiments, cancelling a binding relationship between the robot and the bound user after the bound user finishes using the robot; switching the state of the robot to the idle state.

In some embodiments, after switching the state of the robot into an idle state, determining a path for the robot to move to the predetermined parking place; driving the robot along a determined path to the predetermined parking place to implement automatic homing.

According to a second aspect of an embodiment of the present disclosure, a control apparatus for a robot is provided. The control apparatus comprising: a feature recognition module configured to identify features of users; a locking module configured to identify a bound user by identifying the features of users to determine a current position of the bound user; a path determining module configured to determine a path for the robot to move to an adjacent area of the bound user; a driving module configured to drive the robot to move to the adjacent area of the bound user along the path.

In some embodiments, the control apparatus further comprising: an obstacle detecting module configured to detect whether an obstacle appears in front of the robot in a process of driving the robot to move along the path, instruct the driving module to control the robot to pause in a case where the obstacle appears in front of the robot, detect whether the obstacle disappears after a predetermined time, and instruct the driving module to drive the robot to continue to move along the path in a case where the obstacle disappears.

In some embodiments, the obstacle detection module is further configured to detect a ambient environment of the robot in a case where the obstacle still does not disappear; the path determining module is further configured to re-determine a path for the robot to move to the adjacent area of the bound user according to a result of detection; the driving module is configured to driving the robot to move to the adjacent area of the bound user along the re-determined path.

In some embodiments, in the adjacent area of the bound user, a distance between the robot and the bound user is greater than a first predetermined distance and less than a second predetermined distance, wherein the first predetermined distance is less than the second predetermined distance.

In some embodiments, the control apparatus further comprising: a barcode information identification module configured to identify barcode information on an adjacent shelf in a process of driving the robot to move; a broadcast information inquiry module configured to inquire broadcast information corresponding to the barcode information; a playing module configured to play the broadcast information.

In some embodiments, the control apparatus further comprising: an information matching module configured to extract an identifier of the broadcast information after the broadcast information query module queries the broadcast information, determine whether the identifier matches with historical data of the bound user, and instruct the playing module to play the broadcast information in a case where the identifier matches with the historical data of the bound user.

In some embodiments, the control apparatus further comprising: a voice recognition module configured to acquire voice information of the bound user and recognizing the voice information in a process of driving the robot to move; an instruction processing module configured to analyze the voice instruction to obtain corresponding response information, and in a case where the response information includes a destination address, instruct the path determining module to determine a path for the robot to move to a destination address; the driving module is further configured to drive the robot to move along a determined path to lead the bound user to arrive at the destination address.

In some embodiments, the playing module is further configured to play predetermined guidance information in a process of driving the robot to move along the determined path.

In some embodiments, the playing module is further configured to play reply information in a case where the reply information is included in the response information.

In some embodiments, the control apparatus further comprising: an interaction module configured to receive an instruction issued by an operating user; a state switching module configured to switch a state of the robot to a working state based on a trigger instruction sent by an operating user in a case where the robot is in an idle state, take the operating user as the bound user, and instruct the feature recognition module to recognize the features of the bound user.

In some embodiments, the state switching module is further configured to cancel a binding relationship between the robot and the bound user after the bound user finishes using the robot, and switch the state of the robot to the idle state.

In some embodiments, the path determining module is further configured to determine path for the robot to move to the predetermined parking place after the state switching module switches the state of the robot to an idle state; the driving module is further configured to drive the robot along a determined path to the predetermined parking place to implement automatic homing.

According to a third aspect of an embodiment of the present disclosure, a control apparatus for a robot is provided. The control apparatus comprising: a memory configured to store instructions; a processor coupled to the memory, wherein based on the instructions stored in the memory, the processor is configured to implement the method according to any of the aforementioned embodiments.

According to a fourth aspect of an embodiment of the present disclosure, a robot is provided. The robot comprises the control apparatus according to any of the embodiments described above.

According to a fifth aspect of an embodiment of the present disclosure, a non-transitory computer readable storage medium is provided, wherein the computer readable storage medium stores computer instructions that, when executed by a processor, implement the method in any of the embodiments described above.

Further features of the present disclosure, as well as advantages thereof, will become clearer from the following detailed description of exemplary embodiments of the present disclosure with reference to the accompanying drawings.

### BRIEF DESCRIPTION OF THE DRAWINGS

To explain the embodiments of the present invention or the technical solutions in the prior art more clearly, a brief introduction will be given below for the drawings required in the description of the embodiments or the prior art. Apparently, the drawings illustrated as follows are merely some of the embodiments of the present disclosure. An ordinary person skilled in the art may also acquire other drawings according to such drawings without paying any inventive effort.

FIG. 1 is an exemplary flow chart showing a robot control method according to one embodiment of the present disclosure;

FIG. 2 is an exemplary flow chart showing a robot control method according to another embodiment of the present disclosure;

FIG. 3 is an exemplary block diagram showing a robot control apparatus according to one embodiment of the present disclosure;

FIG. 4 is an exemplary block diagram showing a robot control apparatus according to another embodiment of the present disclosure;

FIG. 5 is an exemplary block diagram showing a robot control apparatus according to still another embodiment of the present disclosure;

FIG. 6 is an exemplary block diagram showing a robot control apparatus according to still another embodiment of the present disclosure;

FIG. 7 is an exemplary block diagram showing a robot control apparatus according to still another embodiment of the present disclosure;

FIG. 8 is an exemplary block diagram showing a robot control apparatus according to still another embodiment of the present disclosure;

FIG. 9 is an exemplary block diagram showing a robot according to one embodiment of the present disclosure.

### DETAILED DESCRIPTION

The technical solutions in the embodiments of the present invention will be clearly and completely described below with reference to the drawings of the embodiments of the present invention. Obviously, the described embodiments are just a part, instead of all, of the embodiments of the present invention. The following description of at least one of the exemplary embodiments is actually merely illustrative, and is not meant to be limitation on the present invention and its application or use in any way. All other embodiments obtained by persons of ordinary skill in the art based on the embodiments of the present invention without paying creative efforts are within the protection scope of the present disclosure.

Unless otherwise specified, relative arrangement of components and steps, numerical expressions and numerical values set forth in these embodiments are not limited within the scope of the present invention.

Meanwhile, it should be understood that, for the convenience of description, the dimensions of the various parts shown in the drawings are not drawn according to the actual proportional relationship.

Techniques, methods, and devices known to an ordinary person skilled in the relevant art may not be discussed in detail but, where appropriate, such techniques, methods, and devices are to be considered part of the description which has been granted a patent right.

In all the examples shown and discussed here, any specific value should be construed as merely illustrative, not as a limitation. Therefore, other examples in the exemplary embodiments may have different values.

It should be noted that similar signs and letters represent similar items in the following figures. Thus, once an item is defined in a figure, it is not required to be further discussed in subsequent figures.

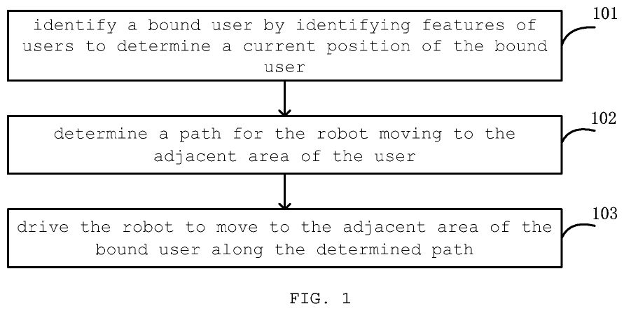

FIG. 1 is an exemplary flow chart showing a robot control method according to one embodiment of the present disclosure. In some embodiments, the steps of the method shown in FIG. 1 are performed by a robot control apparatus.

In step 101, a bound user is identified by identifying features of users to determine a current location of the bound user.

In some embodiments, in the case where the user issues a trigger instruction to the robot in the idle state, for example, by performing a trigger operation using a touch screen on the robot, the robot takes the user as the bound user. The robot obtains the features of the bound user through face recognition and walking gesture recognition, so that the robot can lock the bound user by performing image recognition and determine the current position of the bound user through image processing. For example, after acquiring the features of the bound user, the robot control apparatus can recognize the bound user in a multi-user environment by recognizing the face of a person or the walking posture of the person in the captured image. The robot control apparatus also determines the direction of the bound user relative to the robot and the distance of the bound user relative to the current position of the robot through image recognition. As another example, the robot, after locking the bound user through image recognition, determines the current location of the bound user by recognizing a shelf or other identifier near the bound user.

It should be noted that the robot is an intelligent shopping cart, or other intelligent movable device capable of carrying products.

In some embodiments, the robot can switch between a working state and an idle state. For example, the robot in the idle state switches its own state to the working state after binding with a user.

In step 102, a path for the robot to move to the adjacent area of the bound user is determined.

In some embodiments, the robot performs path planning between a starting point and a ending point by using the current position of the robot as the starting point and the adjacent area of the bound user as the ending point by using the map information of the current location. For example, the robot may determine its own current position by reading a navigation barcode. Since path planning itself is not the inventive point of this disclosure, it is not described here.

In step 103, the robot is driven to move to the adjacent area of the bound user along the determined path.

In some embodiments, in the adjacent area of the bound user, a distance between the robot and the bound user is greater than a first predetermined distance and less than a second predetermined distance, wherein the first predetermined distance is less than the second predetermined distance. That is, the robot may keep a certain distance from the bound user after reaching the adjacent area of the bound user. Therefore, the shopping cart is convenient for users to use, and the walking of the users is not influenced, so that a shopping experience of the users is improved.

According to the robot control method provided by the embodiment of the present disclosure, the user is bound with the robot, and the robot moves by itself to follow the bound user, thereby freeing the user's hands and significantly improving the user experience.

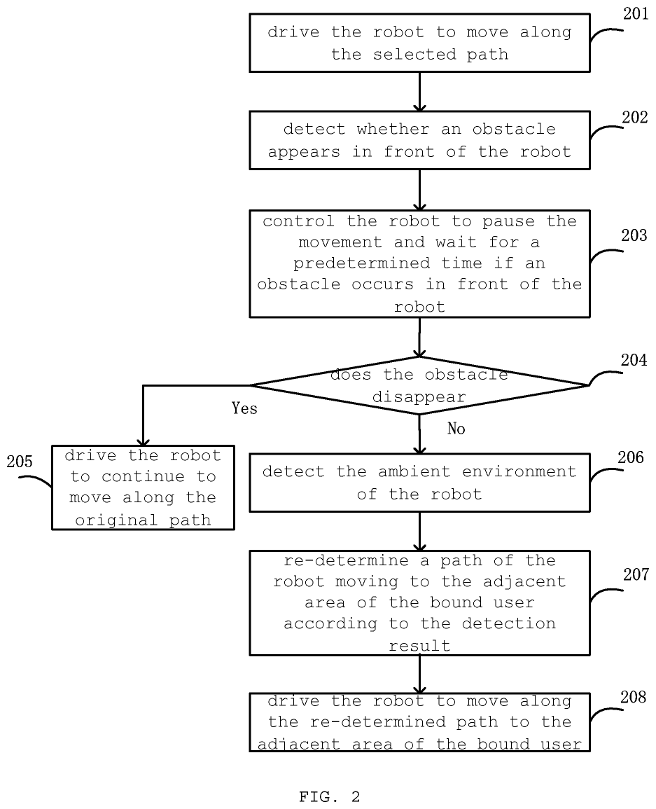

FIG. 2 is an exemplary flow chart showing a robot control method according to another embodiment of the present disclosure.

In some embodiments, the steps of the method shown in FIG. 2 are performed by the robot control apparatus.

In step 201, the robot is driven to move along the selected path.

In step 202, it is detected whether an obstacle appears in front of the robot.

For example, video information in front of the robot can be collected by a camera and analyzed.

In step 203, in the case where an obstacle occurs before the robot, the robot is controlled to pause the movement and wait for a predetermined time.

In step 204, it is detected whether the obstacle disappears. If the obstacle disappears, the processing proceeds to step 205; if the obstacle still has not disappeared, step 206 is executed.

In step 205, the robot is driven to continue to move along the original path.

In step 206, the ambient environment of the robot are detected.

In step 207, a path of the robot to move to the adjacent area of the bound user is re-determined according to the detection result.

In step 208, the robot is driven to move to the adjacent area of the bound user along the re-determined path.

During the movement of the robot, in a case where an obstacle appears in front of the robot, such as another person or robot, the robot may wait for a moment. If the obstacle leaves by itself, the robot continues to move according to the original route. If the obstacle exists all the time, the robot carries out path planning again according to the current position and the target position and moves according to the re-planned path. Therefore, the robot can avoid the obstacle by itself in a process of following the bound user.

In some embodiments, the robot control apparatus identifies barcode information on the adjacent shelf, inquires the broadcast information corresponding to the barcode information and plays the broadcast information in a process of driving the robot to move, so that the bound user can know the commodity information on the adjacent shelf.

For example, corresponding barcode information is arranged on the shelf, and the robot reads the barcode information on the adjacent shelf by performing image recognition in the moving process. The robot obtains and plays broadcast information corresponding to the barcode information, so that the user can know information such as advertisements, promotions and the like related to the commodities on the shelf, which is convenient for shopping for the user.

In some embodiments, the robot control apparatus filters the received broadcast information according to user history data to provide a better user experience. The robot control apparatus extracts the identifier of the broadcast information after querying the broadcast information corresponding to the barcode information. The robot control apparatus determines whether the identifier matches the history data of the bound user. If the identifier is matched with the historical data of the bound user, the robot control apparatus plays the broadcast information. If the identifier does not match with the historical data of the bound user, the robot control apparatus does not play the broadcast information.

For example, the user history data indicates that the user is interested in the electronic product. The robot control apparatus queries the identifier of the broadcast information, and if the information relates to the electronic product information, the robot control apparatus plays the information to the bound user. If the information relates to toothbrush discount promotion, the robot control apparatus does not broadcast the information to the bound user, thereby improving user experience.

In some embodiments, the robot may query the history data of the user corresponding to facial characteristics of the bound user by extracting the facial features, so as to provide personalized services to the user based on the history data of user.

In some embodiments, the robot is also capable of providing navigation services to bound user. For example, the user may issue a voice instruction to the robot. After acquiring the voice information of the bound user, the robot control apparatus identifies the voice information to obtain a voice instruction of the bound user.

The robot control apparatus analyzes the voice command to obtain corresponding response information. If the response information comprises the destination address, the robot control apparatus carries out path planning to determine a path of the robot moving from the current position to the destination address and drives the robot to move along the determined path, so as to guide the bound user to arrive at the destination address.

For example, if the bound user says “seafood”, the robot control apparatus identifies the position of the seafood region, and then performs path planning and drives the robot to move, so as to bring the bound user to the seafood region. For another example, if the bound user says “checkout” or “pay”, the robot controller drives the robot to move, so as to lead the bound user to go to the checkout counter.

In some embodiments, the robot control apparatus further plays predetermined guidance information while driving the robot to move along the determined path. For example, when the robot leads the bound user to go to the destination, guidance information such as “please follow me” is played, so as to improve the user experience.

In some embodiments, the robot may also interact with the bound user to provide communication services for the bound user. For example, the user may send a voice instruction to the robot to ask questions about things of interest. And after acquiring the voice information of the bound user, the robot control apparatus identifies the voice information to obtain a voice instruction of the bound user.

The robot control apparatus analyzes the voice command to obtain corresponding response information. And if the response information comprises the reply information, the reply information is played, so as to interact with the bound user.

For example, if the user asks for about the price of a certain product, the robot control apparatus interacts with the service server to provide information such as main manufacturers for producing the product, product characteristics and product price to the user, so that the interest and convenience of shopping of the user are improved, and the robot control apparatus can also serve as a window for publicizing commodities and issuing promotion information on manufacturers and brands.

In some embodiments, after the bound user finishes using the robot, the robot control device cancels the binding relationship between the robot and the bound user, and switches a state of the robot to the idle state. For example, the user may click on the touch screen after finishing use or checkout to perform a corresponding operation to switch the robot's state to an idle state, so that the robot continues to provide service to other users.

In some embodiments, after switching the state of the robot to the idle state, the robot control apparatus may further determine a path along which the robot moves from the current position to the predetermined parking place by performing path planning, and drive the robot to move to the predetermined parking place along the determined path, so as to achieve automatic homing.

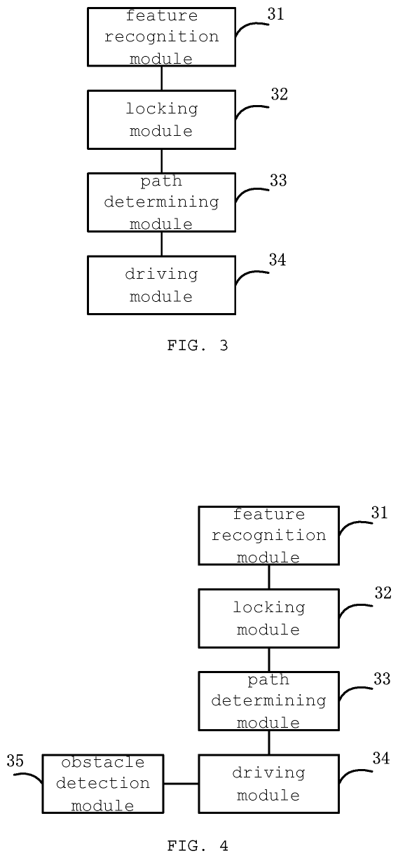

FIG. 3 is an exemplary block diagram showing a robot control apparatus according to one embodiment of the present disclosure.

As shown in FIG. 3, the robot control apparatus includes a feature recognition module 31, a locking module 32, a path determining module 33, and a driving module 34. The feature recognition module 31 is used to recognize features of users. For example, the feature recognition module 31 performs face recognition or walking gesture recognition to acquire the features of user. The locking module 32 is used for identifying a bound user by identifying the features of users to determine a current position of the bound user.

For example, after acquiring the features of the bound user, the robot control apparatus can recognize the bound user in a multi-user environment by recognizing the face or the walking posture of the person in the captured image. The robot control apparatus also determines the direction of the bound user relative to the robot and the distance of the bound user relative to the current position of the robot through image recognition. As another example, the robot, after locking the bound user through image recognition, determines the current location of the bound user by recognizing a shelf or other identifier proximate to the bound user.

The path determination module 33 is used to determine the path of the robot to move to the adjacent area of the bound user. The drive module 34 is used for driving the robot to move along the path to the adjacent area of the bound user.

In some embodiments, in the adjacent area of the bound user, the distance between the robot and the bound user is greater than a first predetermined distance and less than a second predetermined distance, wherein the first predetermined distance is less than the second predetermined distance. Therefore, the shopping cart is convenient for users to use, and the walking of the users is not influenced, so that the shopping experience of the users is improved.

By using the robot control apparatus provided by the embodiment of the present disclosure, the user is bound with the robot, so that the robot moves by itself to follow the bound user, thereby liberating the user's hands and significantly improving the user experience.

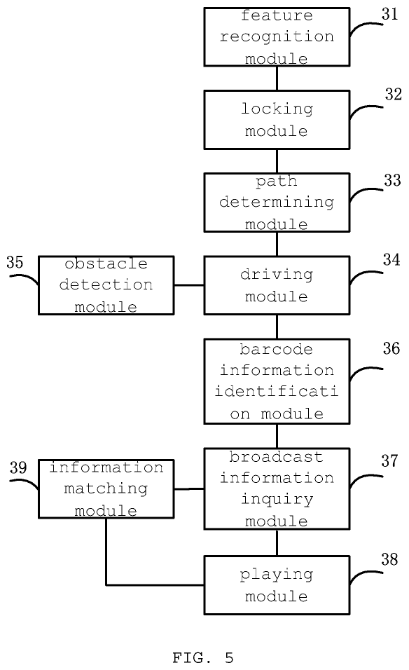

FIG. 4 is an exemplary block diagram showing a robot control apparatus according to another embodiment of the present disclosure. FIG. 4 differs from FIG. 3 in that, in the embodiment shown in FIG. 4, the robot control apparatus further includes an obstacle detection module 35.

The obstacle detection module 35 is used for detecting whether an obstacle appears in front of the robot in a process that the driving module 34 drives the robot to move along the path. If an obstacle appears in front of the robot, the obstacle detection module 35 instructs the driving module to control the robot to pause the movement, and detects whether the obstacle disappears after a predetermined time has elapsed. If the obstacle disappears, the obstacle detection module 35 instructs the driving module 34 to drive the robot to move along the path continuously.

In some embodiments, the obstacle detection module 35 is further configured to detect the ambient environment of the robot in a case where the obstacle does not disappear after a predetermined time has elapsed. The path determining module 33 is further configured to re-determine a path of the robot moving from the current position to the adjacent area of the bound user according to the detection result. The drive module 34 is also used to drive the robot to move along the re-determined path to the adjacent area of the bound user.

In some embodiments, the robot can realize self-detour according to the current environment in the case that an obstacle appears in front of it during movement.

FIG. 5 is an exemplary block diagram showing a robot control apparatus according to still another embodiment of the present disclosure. FIG. 5 differs from FIG. 4 in that, in the embodiment shown in FIG. 5, the robot control apparatus further includes a barcode information identification module 36, a broadcast information inquiry module 37, and a playing module 38.

The barcode information identification module 36 is used for identifying barcode information on an adjacent shelf in a process that the driving module drives the robot to move. The broadcast information inquiry module 37 is used to inquire the broadcast information corresponding to the barcode information. The play module 38 is used to play the broadcast information, so that the bound user knows the information of the products on the adjacent shelf. Thus, the information of advertisement, promotion and the like of the commodities on the adjacent shelf can be known conveniently.

In some embodiments, as shown in FIG. 5, the robot control apparatus further includes an information matching module 39. The information matching module 39 is used for extracting a identifier of the broadcast information after the broadcast information inquiry module 37 inquires about the broadcast information corresponding to the barcode information, and determining whether the identifier matches with historical data of the bound user. If the identification matches the history data of the bound user, the information matching module 39 instructs the playing module 38 to play the broadcast information.

That is, the robot control apparatus only plays information of interest to the user based on the user history data. For example, the robot control apparatus knows that the user is interested in the electronic product according to the historical data, so that only relevant information of the electronic product is played, while a toothbrush promotion advertisement is not played for the user, thereby improving the user experience.

For example, the corresponding user history data may be determined by identifying facial features of the user. Thus, the user can obtain personalized services by “face swiping”.

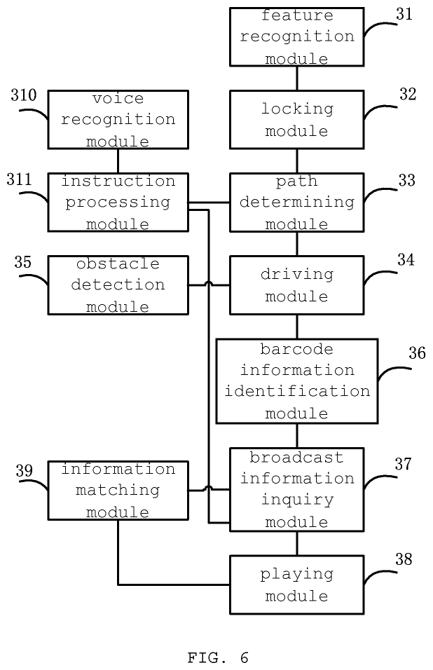

FIG. 6 is an exemplary block diagram showing a robot control apparatus according to still another embodiment of the present disclosure. FIG. 6 differs from FIG. 5 in that, in the embodiment shown in FIG. 6, the robot control apparatus further includes a voice recognition module 310 and an instruction processing module 311.

The voice recognition module 310 is configured to recognize the voice information after acquiring the voice information of the bound user, so as to obtain a voice instruction of the bound user. The instruction processing module 311 is configured to analyze and process the voice instruction to obtain corresponding response information, and if the response information includes a destination address, instruct the path determining module 33 to determine a path along which the robot moves to the destination address. The drive module 34 is also used to drive the robot to move along a determined path to lead the bound user to the destination address.

Thus, the user can obtain the navigation service by sending a voice instruction. For example, if the bound user says “seafood”, the robot control apparatus identifies the position of the seafood region, and then performs path planning and drives the robot to move, so as to bring the bound user to the seafood region.

In some embodiments, the playing module 38 is further configured to play the predetermined guidance information when the driving module 34 drives the robot to move along the determined path. For example, guidance information such as “please follow me” may be played during the lead process to enhance the user experience.

In some embodiments, the playing module 38 is further configured to play reply information for interaction with the bound user when the reply information is included in the response information. For example, if the user inquires about the price of a certain product, the robot control apparatus interacts with the service server to provide information such as main manufacturers for producing the product, product characteristics and product price to the user, so that the interest and convenience of shopping of the user are improved, and the robot control apparatus can also serve as a window for publicizing commodities and issuing promotion information on manufacturers and brands.

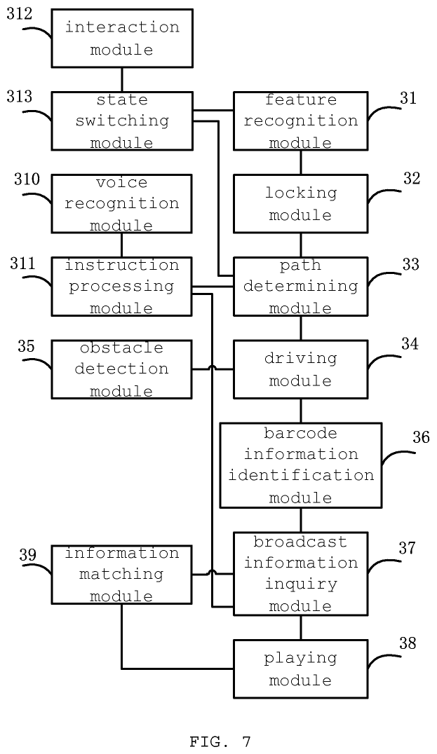

FIG. 7 is an exemplary block diagram showing a robot control apparatus according to still another embodiment of the present disclosure. FIG. 7 differs from FIG. 6 in that, in the embodiment shown in FIG. 7, the robot control apparatus further includes an interaction module 312 and a state switching module 313.

The interaction module 312 is used for receiving an instruction issued by an operating user. For example, the interaction module 312 is a touch screen or other interactive devices capable of receiving user instructions. The state switching module 313 is configured to switch the state of the robot to the working state based on a trigger instruction sent by the operating user when the robot is in the idle state, take the operating user as a bound user, and instruct the feature recognition module 31 to perform user feature recognition to the bound user.

In some embodiments, the state switching module 313 is further configured to cancel the binding relation between the robot and the bound user after the bound user finishes using the robot, and switch the state of the robot to the idle state, so that the robot continues to provide services for other users.

In some embodiments, the path determining module 33 is further configured to determine a path for the robot to move to the predetermined parking place after the state switching module switches the state of the robot to the idle state. The drive module 34 is also used to drive the robot along a determined path to a predetermined parking place for automatic homing.

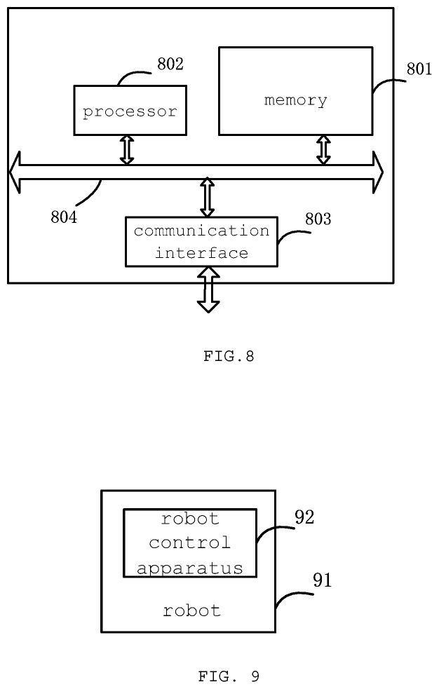

FIG. 8 is an exemplary block diagram showing a robot control apparatus according to still another embodiment of the present disclosure.

As shown in FIG. 8, the robot control apparatus includes a memory 801 and a processor 802. The memory 801 is used for storing instructions, and the processor 802 is coupled to the memory 801 and configured to implement the method as referred to in any of the embodiments of FIGS. 1-2 based on the instructions stored in the memory.

As shown in FIG. 8, the robot control apparatus also includes a communication interface 803 for performing information interaction with other devices. Meanwhile, the device also includes a bus 804, so that the processor 802, the communication interface 803 and the memory 801 perform communication with each other via the bus 804.

The Memory 801 may comprise a Random-Access Memory (RAM) and may also comprise a non-volatile Memory, such as at least one disk Memory. The memory 801 may also be a memory array. The memory 801 may also be partitioned into blocks, which may be combined into virtual volumes according to certain rules.

In some embodiments, the processor 802 may be a central processing unit CPU, or may be an Application Specific Integrated Circuit (ASIC), or one or more integrated circuits configured to implement embodiments of the present disclosure.

FIG. 9 is an exemplary block diagram showing a robot according to one embodiment of the present disclosure.

As shown in FIG. 9, the robot 91 includes a robot control apparatus 92. The robot control apparatus 92 is a robot controller according to any one of the embodiments shown in FIGS. 3 to 8.

By using the robot provided by the embodiment of the present disclosure, the robot moves by itself to follow the bound user, thereby freeing the user's hands and significantly improving the user experience.

In some embodiments, the functional unit modules described in the above embodiments may be implemented as general-purpose processors, programmable logic controllers (PLC), digital signal processors (DSP), application specific integrated circuits (ASIC), field-programmable gate arrays (FPGA) or other programmable logic devices, discrete gate or transistor logic devices, discrete hardware components, or any suitable combination thereof for performing the functions described in the present disclosure.

The present disclosure also provides a computer-readable storage medium, wherein the computer-readable storage medium stores computer instructions that, when executed by a processor, implement a method as referred to in any of the embodiments of FIG. 1 or FIG. 2. Those skilled in the art will appreciate that embodiments of the present disclosure may be provided as a method, apparatus, or computer program product. Therefore, the embodiments of the present disclosure can take the form of an entirely hardware embodiment, an entirely software embodiment or an embodiment containing both hardware and software elements. Moreover, this disclosure can be in a form of one or more computer program products containing the computer-executable codes which can be implemented in the computer-executable non-transitory storage media (including but not limited to disk memory, CD-ROM, optical memory, etc.).

By implementing the present disclosure, at least one of the following advantageous effects can be obtained:

1) A robot such as an intelligent shopping cart can follow the bound user by self, so that the hands of the user can be liberated, and the user can conveniently select commodities, use a mobile phone and the like. The advantages are more obvious for the users who hold a baby or have inconvenience in moving.

2) A navigation service is provided for the user, a path can be planned according to the user's requirement, and the user is guided to the destination, so that the time is effectively saved.

3) And communication service can be provided for the user. The user's questions about, for example, shopping malls, supermarkets, commodities, promotions or other questions can be answered, thereby improving the interest of shopping of the user and ensuring that the user can acquire necessary information. Meanwhile, the invention can also be used as a window for manufacturers and branders to publicize commodities and promote sales information.

Those skilled in the art will appreciate that embodiments of the present disclosure may be provided as a method, system, or computer program product. Therefore, the embodiments of the present disclosure can take the form of an entirely hardware embodiment, an entirely software embodiment or an embodiment containing both hardware and software elements. Moreover, this disclosure can be in a form of one or more computer program products containing the computer-executable codes which can be implemented in the computer-executable non-transitory storage media (including but not limited to disk memory, CD-ROM, optical memory, etc.).

The present disclosure is described with reference to the flow charts and/or block diagrams of the method, device (system) and computer program product according to the embodiments of the present disclosure. It shall be understood that each flow and/or block in the flowcharts and/or block diagrams and a combination of the flows and/or blocks in the flowcharts and/or block diagrams can be implemented by computer program instructions. These computer program instructions can be provided to a general purpose computer, a special purpose computer, an embedded processor, or a processor of other programmable data processing devices so as to generate a machine for generating means for implementing the functions of one or more flows of a flowchart and/or one or more blocks of a block diagram by using the instructions executed by the computer or the processor of other programmable data processing devices.

These computer program instructions can also be stored in a computer readable memory guiding the computer or other programmable data processing devices to work in a particular way, such that the instructions stored in the computer readable memory generate an article of manufacture containing instruction means which implement the functions of one or more flows of a flowchart and/or one or more blocks in a block diagram.

These computer program instructions can also be loaded onto a computer or other programmable data processing devices such that a series of operational steps are performed on a computer or other programmable devices to produce computer-implemented processing, so that the instructions executed on a computer or other programmable devices provide steps for implementing the functions of one or more flows of a flowchart and/or one or more blocks of a block diagram.

The description of the present disclosure has been presented for purposes of illustration and description, and is not intended to be exhaustive or limited to the disclosure in the form disclosed. Many modifications and variations will be apparent to those of ordinary skill in the art. The embodiments were chosen and described in order to better explain the principles and the practical application of the disclosure, and to enable those of ordinary skill in the art to understand the disclosure and to design various embodiments with different modification suitable for particular uses.

1. A control method for a robot, comprising:
identifying a bound user by identifying features of users to determine a current position of the bound user;
determining a first path for the robot to move to an adjacent area of the bound user; and
driving the robot to move to the adjacent area of the bound user along the first path.

2. The control method according to claim 1, wherein the driving the robot comprises:
detecting whether an obstacle appears in front of the robot in a process of driving the robot to move along the first path;
controlling the robot to pause in a case where the obstacle appears in front of the robot;
detecting whether the obstacle disappears after a predetermined time;
driving the robot to continue to move along the first path in a case where the obstacle disappears;
detecting a ambient environment of the robot in a case where the obstacle still does not disappear;
re-determining a second path for the robot to move to the adjacent area of the bound user according to a result of detection; and
driving the robot to move to the adjacent area of the bound user along the second path.

3. (canceled)

4. The control method according to claim 1, wherein P1 in the adjacent area of the bound user, a distance between the robot and the bound user is greater than a first predetermined distance and less than a second predetermined distance, wherein the first predetermined distance is less than the second predetermined distance.

5. The control method according to claim 1, further comprising:
identifying barcode information on an adjacent shelf in a process of driving the robot to move;
inquiring broadcast information corresponding to the barcode information; and
playing the broadcast information.

6. The control method according to claim 5, wherein the playing the broadcast information comprises:
extracting an identifier of the broadcast information;
determining whether the identifier matches with historical data of the bound user; and
playing the broadcast information in a case where the identifier matches with the historical data of the bound user.

7. The control method according to claim 1, further comprising:
acquiring voice information of the bound user and recognizing the voice information in a process of driving the robot to move;
analyzing the voice instruction to obtain corresponding response information; and
determining a third path for the robot to move to a destination address in a case where the destination address is included in the response information;
driving the robot to move along the third path to lead the bound user to arrive at the destination address.

8. The control method according to claim 7, wherein
playing predetermined guidance information in a process of driving the robot to move along the third path.

9. The control method according to claim 7, wherein
playing reply information in a case where the reply information is included in the response information.

10. The control method according to claim 1, 4-9, further comprising:
switching a state of the robot to a working state based on a trigger instruction sent by an operating user in a case where the robot is in an idle state;
taking the operating user as the bound user and recognizing the features of the bound user;
cancelling a binding relationship between the robot and the bound user after the bound user finishes using the robot;
switching the state of the robot to the idle state;
determining a fourth path for the robot to move to the predetermined parking place; and
driving the robot along the fourth path to the predetermined parking place to implement automatic homing.

11-24. (canceled)

25. A control apparatus for a robot, comprising:
a memory configured to store instructions;
a processor coupled to the memory, wherein based on the instructions stored in the memory, the processor is configured to:
identify a bound user by identifying features of users to determine a current position of the bound user;
determine a first path for the robot to move to an adjacent area of the bound user; and
drive the robot to move to the adjacent area of the bound user along the first path.

26. A robot, comprising the control apparatus for a robot according to claim 25.

27. A non-transitory computer readable storage medium, wherein the computer readable storage medium stores computer instructions which, when executed by a processor on a computing device, cause the computing device to:
identify a bound user by identifying features of users to determine a current position of the bound user;
determine a first path for the robot to move to an adjacent area of the bound user; and
drive the robot to move to the adjacent area of the bound user along the first path.

28. The robot according to claim 26, further comprising:
an image sensor configured to acquire an image and send the image to the control apparatus.

29. The robot according to claim 26, further comprising:
a speaker configured to play information sent by the control apparatus.

30. The control apparatus according to claim 25, wherein the processor is configured to:
detect whether an obstacle appears in front of the robot in a process of driving the robot to move along the first path;
control the robot to pause in a case where the obstacle appears in front of the robot;
detect whether the obstacle disappears after a predetermined time;
drive the robot to continue to move along the first path in a case where the obstacle disappears;
detect a ambient environment of the robot in a case where the obstacle still does not disappear;
re-determine a second path for the robot to move to the adjacent area of the bound user according to a result of detection; and
drive the robot to move to the adjacent area of the bound user along the second path.

31. The control apparatus according to claim 25, wherein
in the adjacent area of the bound user, a distance between the robot and the bound user is greater than a first predetermined distance and less than a second predetermined distance, wherein the first predetermined distance is less than the second predetermined distance.

32. The control apparatus according to claim 25, wherein the processor is configured to:
identify barcode information on an adjacent shelf in a process of driving the robot to move;
inquire broadcast information corresponding to the barcode information; and
play the broadcast information.

33. The control apparatus according to claim 32, wherein the processor is configured to:
extract an identifier of the broadcast information;
determine whether the identifier matches with historical data of the bound user; and
play the broadcast information in a case where the identifier matches with the historical data of the bound user.

34. The control apparatus according to claim 25, wherein the processor is configured to:
acquire voice information of the bound user and recognize the voice information in a process of driving the robot to move;
analyze the voice instruction to obtain corresponding response information;
determine a third path for the robot to move to a destination address in a case where the destination address is included in the response information;
drive the robot to move along the third path to lead the bound user to arrive at the destination address;
play predetermined guidance information in a process of driving the robot to move along the third path; and
play reply information in a case where the reply information is included in the response information.

35. The control apparatus according to claim 25, wherein the processor is configured to:
switch a state of the robot to a working state based on a trigger instruction sent by an operating user in a case where the robot is in an idle state;
take the operating user as the bound user and recognizing the features of the bound user;
cancel a binding relationship between the robot and the bound user after the bound user finishes using the robot;
switch the state of the robot to the idle state;
determine a fourth path for the robot to move to the predetermined parking place; and
drive the robot along the fourth path to the predetermined parking place to implement automatic homing.
